(19) United States
(12) Patent Application Publication
(10) Pub. No.: US 2016/0370614 A1
(43) Pub. Date: Dec. 22, 2016

(54) LASER PROCESSING APPARATUS, METHODS OF LASER-PROCESSING WORKPIECES AND RELATED ARRANGEMENTS

(71) Applicant: ELECTRO SCIENTIFIC INDUSTRIES, INC., Portland, OR (US)

(72) Inventors: Guillaume Blanchette, Montreal (CA); James Cordingley, Littleton, MA (US); Joseph John Griffiths, Winthrop, MA (US)

(21) Appl. No.: 15/182,179

(22) Filed: Jun. 14, 2016

Related U.S. Application Data
(60) Provisional application No. 62/180,358, filed on Jun. 16, 2015.
(60) Provisional application No. 62/304,411, filed on Mar. 7, 2016.

(51) Int. Cl. G02F 1/13; G02F 1/1335

(52) U.S. Cl. CPC G02F 1/1309; G02F 1/133514

(57) ABSTRACT

Numerous embodiments concerning methods and apparatus for processing a workpiece are disclosed. In one embodiment, an electronic display device having a plurality of viewing elements is provided, wherein a viewing element includes a color element and at least one viewing element exhibits a bright pixel defect. The color element of the viewing element exhibiting the bright pixel defect can be darkened by irradiating the color element with at least one laser pulse having a pulse duration in a range from 1 ps to 40 ps.

### CROSS-REFERENCE TO RELATED APPLICATIONS

This application claims benefit of U.S. Provisional Application No. 62/180,358, filed Jun. 16, 2015, and U.S. Provisional Application No. 62/304,411, filed Mar. 7, 2016, each of which is incorporated by reference in its entirety.

### TECHNICAL FIELD

Embodiments of the present invention relate generally to laser processing of workpieces. Some particular embodiments relate to repair of electronic devices that include arrays of discrete circuits, any one of which may be isolated in the event that the discrete circuit is defective. Other particular embodiments relate to the repair of display panels such as liquid crystal display panels, organic light emitting diode (OLED) displays, and the like.

### BACKGROUND

Electronic display devices such as liquid crystal displays (LCDs), organic light-emitting diode (OLED) displays, quantum dot (QD) displays, etc., are typically formed of an array of pixels, each capable of emitting, reflecting, otherwise transmitting multiple colors of light (e.g., red, green and blue, or cyan, magenta, yellow and black, or the like) for viewing by a viewer. Likewise, each pixel can be considered as a set of sub-pixels, each capable of emitting, reflecting, otherwise transmitting one color of light. Thus, any “pixel” and any “sub-pixel” can also be generically referred to simply as a “viewing element.” Viewing elements can be selectively driven to emit, reflect, or transmit light (to attain a “bright” state) or to refrain from doing so (to attain a “dark” state) according to one or more addressing schemes (e.g., direct addressing, active matrix addressing, passive matrix addressing etc.). To enable addressing of viewing elements, a transistor (and, optionally, a capacitor) may be coupled to one or more electrodes associated with one or more viewing elements. Transistors can then be turned on or off (thus, turning the viewing elements “on” or “off”) according to a suitable or desirable addressing scheme.

The composition of a viewing element can vary depending on the electronic display device in which it is found. For example, a viewing element in a LCD can include a color filter (e.g., formed of a photosensitive material) for selectively transmitting a particular color of light (e.g., red, blue, green, magenta, cyan, yellow, etc.). A viewing element in an OLED display can include a color emitter (e.g., formed of OLED) for emitting a particular color of light (e.g., red, blue, green, magenta, cyan, yellow, etc.). Thus, components such as color filters, color emitters, etc., are also referred to herein simply as a “color element.”

It is known that individual transistors may be defective upon manufacturing, and that these defects may cause a viewing element to remain dark even when it is turned on, or may cause the viewing element to remain bright when power is applied to the electronic display but the viewing element is turned off. Generally, a defective viewing element that remains in a dark state when it is intended to be in a bright state (i.e., a dark pixel defect) is not a significant problem because the human eye will likely not notice a tiny viewing element (e.g., a single pixel or sub-pixel) failing to turn on in an overall array of viewing elements operating properly. On the other hand, a defective viewing element that remains in a bright state when it is intended to be in a dark state (i.e., a bright pixel defect) is readily noticeable.

Many procedures have been developed for attempting to reduce, eliminate or otherwise repair bright pixel defects. With respect to LCDs, some techniques attempt to repair bright pixel defects by decreasing light transmittance characteristics of color filters (i.e., to darken or blacken the color filter) associated with viewing elements exhibiting bright pixel defects. Known techniques to darken color filters involve directing laser pulses having pulse widths in the femtosecond (fs) and nanosecond (ns) regimes. While laser pulses having pulse widths in the fs regime are effective at darkening color filters, many laser systems capable of producing suitable femtosecond laser pulses can be undesirably expensive. Laser systems capable of generating laser pulses having pulse widths in the ns regime are generally less expensive than femtosecond laser systems, but laser pulses in the ns regime are less effective at darkening color filters in a reliable and reproducible manner. Moreover, heat accumulated from such laser pulses having can, undesirably, damage adjacent regions of the color filter substrate and create bubbles in the adjacent liquid crystal layer.

### SUMMARY

One embodiment of the present invention can be characterized as a method that includes providing an electronic display device having a plurality of viewing elements each comprising a color element, wherein at least one viewing element exhibits a bright pixel defect; and darkening the color element of at least one viewing element exhibiting the bright pixel defect. The darkening can be accomplished by irradiating the color element with at least one laser pulse having a pulse duration in a range from 1 ps to 40 ps.

Another embodiment of the present invention can be characterized as an apparatus that includes: a workpiece support structure configured to support an electronic display device having a plurality of viewing elements each comprising a color element, wherein at least one viewing element exhibits a bright pixel defect; an optical repair system configured to darken the color element of at least one viewing element exhibiting the bright pixel defect, the optical repair system including a laser system configured to irradiate the color element with at least one laser pulse having a pulse duration in a range from 1 ps to 40 ps; and a relative position system configured to move at least one of the workpiece support structure and the optical repair system sufficient to arrange the color element of the at least one viewing element within a processing field of the optical repair system.

### BRIEF DESCRIPTION OF THE DRAWINGS

FIG. 1 shows an illustrative diagrammatic partial cross-sectional view of a liquid crystal display in which an optical repair system and process may be employed in accordance with an embodiment of the present invention.

FIG. 2 shows an illustrative diagrammatic plan view of an electronic display device showing three color elements, one of which exhibiting a dark defect and another exhibiting a bright pixel defect.

FIGS. 3A-3C show illustrative diagrammatic plan views of a portion of an electronic display device at three successive points in time during which a beam of laser pulses is employed to darken a color element exhibiting a bright pixel defect.

FIG. 4 shows an illustrative diagrammatic schematic view of an optical repair system coupled to a gantry system, in accordance with an embodiment of the invention.

FIG. 5 shows an illustrative diagrammatic schematic view of an optical repair system incorporating a fiber delivery system, in accordance with an embodiment of the invention.

### DETAILED DESCRIPTION

Example embodiments are described below with reference to the accompanying drawings. Many different forms and embodiments are possible without deviating from the spirit and teachings of this disclosure and so this disclosure should not be construed as limited to the example embodiments set forth herein. Rather, these example embodiments are provided so that this disclosure will be thorough and complete, and will convey the scope of the disclosure to those skilled in the art. In the drawings, the sizes and relative sizes of components may be disproportionate and/or exaggerated for clarity. The terminology used herein is for the purpose of describing particular example embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween.

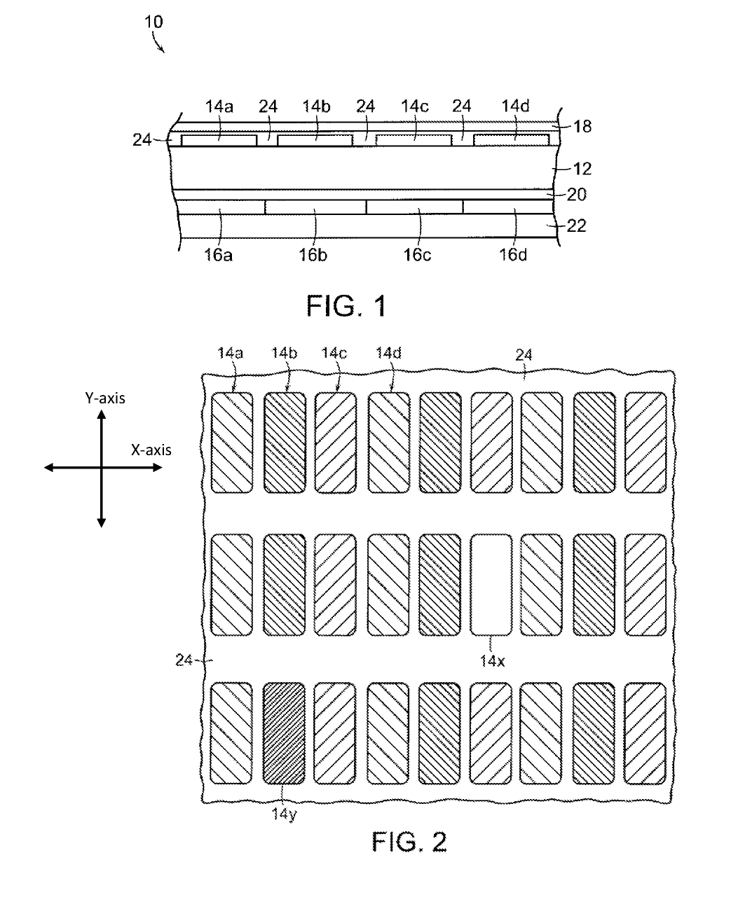

As shown in FIG. 1, an LCD may include a liquid crystal layer 12, a plurality of color filters 14a, 14b, 14c and 14d, a transparent electrode layer including individual transistor elements 16a, 16b, 16c and 16d an upper polarizing film 18, a lower polarizing film 20 and an illumination panel 22 (e.g., a light guide panel, one or more backlights, etc.). The color filters may be provided in sets of three, for example, where color filters 14a and 14d are red, color filter 14b is green and color filter 14c is blue. LCDs which can be repaired according to the processes described herein can have any suitable or desirable resolution, including standard-definition television (SDTV), full-high-definition (FHD), ultra-high-definition television (UHD) (including 4K UHD, 8K UHD), or the like.

Generally, a liquid crystal display (LCD) can be thought of as a sandwich of different functional layers generally including a top polarizer, a color filter array, a liquid crystal layer, a bottom polarizer and an optional illuminator (e.g., a back light). Each of the polarizers has a polarization axis corresponding to the polarization axis of light that is transmitted through the respective polarizer. The liquid crystal layer is controlled to rotate the polarization axis of light between the top and bottom polarizers and thereby control transmission of light though the LCD.

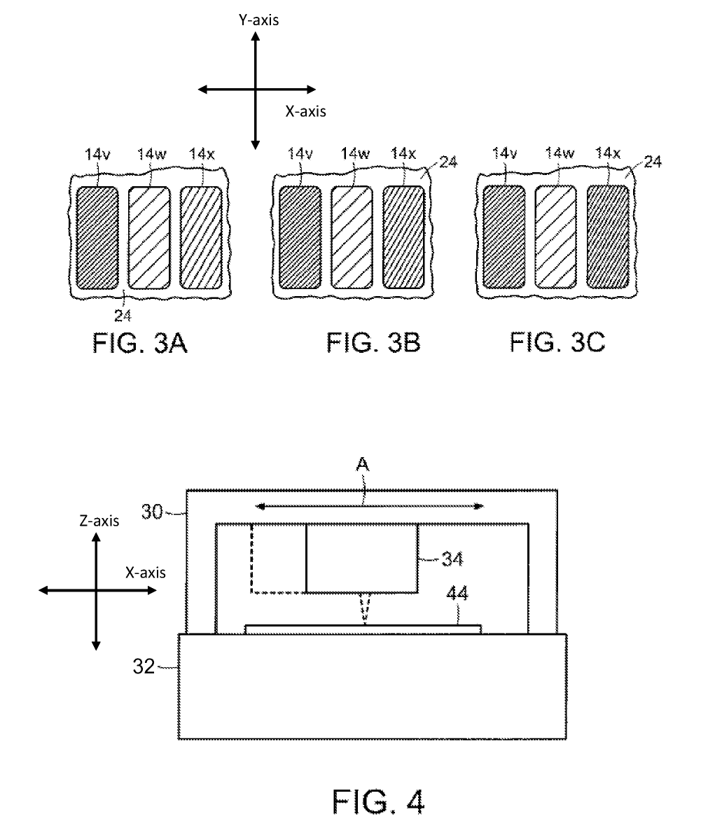

As further shown in FIG. 2, the array of color filters may be provided within a matrix 24 of a black plastic material to minimize transmission of undesired light. The electronic display device may include a plurality of defective viewing elements. For example, the viewing element associated with color filter 14x is shown as exhibiting a bright pixel defect, and the viewing element associated with color filter 14y is shown as exhibiting a dark defect. In accordance with embodiments of the present invention, the bright pixel defect can be repaired by subjecting the color filter 14x to a “direct blackening” process. In a direct blackening process, color filter (e.g., color filter 14x) is irradiated with one or more laser pulses characterized by one or more parameters selected to darken the color filter. For example, as shown in FIGS. 3A-3C, a color filter 14x associated with a bright pixel defect may be darkened by irradiating one or more laser pulses to the color filter 14x.

As shown in FIG. 4, a gantry 30 carries an optical repair system 34 over a workpiece 44 (e.g., an LCD panel) supported by a workpiece support structure 32 (e.g., a base) and positions the optical repair system 34 over defective viewing elements that need to be repaired. For example, the gantry 30 can be coupled to one or more stages configured to move the gantry 30 relative to the workpiece support structure 32 along the Y-axis, and the optical repair system 34 may be coupled to one or more stages configured to move the optical repair system 34 relative to the gantry 30 along the X-axis (as indicated by arrow A). Other well-known relative positioning systems such as a stacked stage system (e.g., in which stages configured to move the workpiece 44 along the X- and Y-axes are coupled between the workpiece 44 and the workpiece support structure 32), split stage system (e.g., in which one of the gantry 30 or the optical repair system 34 is stationary such that the optical repair system 34 is moveable along only one of two axes, and a stage is coupled between the workpiece 44 and the workpiece support structure 32 such that the workpiece 44 is moveable along another of two axes), etc., may be used to position the optical repair system 34 over defective viewing elements.

Relative motion between the optical repair system 34 and the workpiece 44 may be in the range of a few hundred millimeters to greater than 1 meter. It is expected that the range of relative motion will continue to increase to accommodate larger panels and available mother glass substrates sizes. For example current mother glass sizes range from 1st generation (e.g., 300 mm×400 mm) to 10th generation (e.g., 2850 mm×3050 mm) and beyond. The function of the optical repair system 34 can be largely independent of the range of motion over the workpiece 44, although large substrates with many repairs benefit from fast repair and increased throughput.

Generally, the optical repair system 34 is configured to generate a beam of laser pulses, which can be directed toward the workpiece 44 (i.e., into the color filter material) to repair bright pixel defects associated with the workpiece 44 (e.g., by darkening the color filter material associated with a bright pixel defect). The optical repair system 34 can be provided in any suitable or desirable manner (e.g., as described in one or more of U.S. Patent App. Pub. No. 2014/0256205 and U.S. Pat. Nos. 8,928,853, 8,785,810, 7,868,993, 7,755,380, 7,636,148, 7,502,094, 6,812,992, or any combination thereof, each of which is incorporated by reference in its entirety). Nevertheless, it will be appreciated, that the optical repair system 34 includes a laser system a configured to generate a beam of laser pulses, which can be directed toward the workpiece 44 (i.e., into the color filter material). Generally, the beam of laser pulses is characterized by one or more parameters that cause the color filter material associated with bright pixel defects to become darkened when the color filter material is irradiated by one or more of the laser pulses. Example parameters can include wavelength, spot size, pulse duration and pulse energy.

In one embodiment, the laser system includes one or more laser sources operative to generate laser light (e.g., as a series of pulses, as a continuous beam, or the like or any combination thereof) having one or more wavelengths in the infra-red (IR) range of the electromagnetic spectrum, one or more wavelengths in the green range of the electromagnetic spectrum, one or more wavelengths in the ultraviolet (UV) range of the electromagnetic spectrum, or the like or any combination thereof.

In one embodiment, pulses within the beam of laser pulses may have a pulse duration in a range from 1 picosecond (ps) to 40 ps. In another embodiment, the pulse duration may be in a range from 1 ps to 15 ps. In yet another embodiment, the pulse duration may be in a range from 1 ps to 5 ps. It will be appreciated that the pulse duration of at least one laser pulse may be less than 1 ps, or may be slightly more than 40 ps. The inventors have discovered, however, that if the pulse duration exceeds significantly more than 40 ps, the aforementioned deleterious effects associated with prior art darkening techniques employing laser pulses having durations in the ns regime can be noticed.

In one embodiment, the pulse energy of each laser pulse can be set in a range from 3 nanojoules (nJ) (or thereabout) to 50 μJ (or thereabout). In one embodiment, the pulse energy of each pulse can be set in a range from 4.5 nJ (or thereabout) to 10 μJ (or thereabout). In one embodiment, the pulse energy of each pulse can be set in a range from 4.5 nJ (or thereabout) to 6 nJ (or thereabout). In some embodiments, the pulse energy in each pulse can be set in correspondence with the pulse duration, where pulses having relatively longer pulse durations associated have relatively higher pulse energies. It will be appreciated, however, that pulses of different pulse durations can have the same pulse energies, and that the pulse energy in a pulse need not be set in correspondence with the pulse duration of that pulse.

In one embodiment, the beam of laser pulses may be focused at the workpiece 44 (e.g., at a color filter associated with a bright pixel defect) to a spot size of 3 μm (or thereabout) or less. In another embodiment, the beam of laser pulses is focused to a spot size of 2.5 μm (or thereabout) or less. In another embodiment, the beam of laser pulses is focused to a spot size of 1.75 μm (or thereabout) or less. In yet another embodiment, the beam of laser pulses is focused to a spot size of 0.875 μm (or thereabout). In some embodiments, the spot size to which the laser pulse is focused corresponds to the wavelength (or range of wavelengths) of the laser pulse. For example, IR laser pulses can be focused to a spot size of 2.5 μm (or thereabout), green laser pulses can be focused to a spot size of 1.75 μm (or thereabout) and UV laser pulses can be focused to a spot size of 0.875 μm (or thereabout). In other embodiments however, the spot size to which the laser pulse is focused does not correspond to the wavelength (or range of wavelengths) of the laser pulse.

In addition to the laser system, the optical repair system 34 may include additional components such as a beam modification system operative to modify (e.g., collimate, shape, expand, focus, or the like or a combination thereof) the laser pulses, a beam steering system (e.g., one or more galvo-mirrors, fast-steering mirrors, acousto-optic deflectors, adaptive optics, piezoelectric actuators, or the like or a combination thereof) operative to rapidly and accurately scan the laser pulses to specific locations (e.g., along X-, Y- and Z-axes) within a processing field of the optical repair system 34 that lies on or within the workpiece 44. It can be desirable to use a scan lens having a relatively high numerical aperture (NA) to constrain the location of the focal spot of the beam of laser pulses to a specific location (or within a specific range) in the Z axis; thereby minimizing the likelihood that the focused beam of laser pulses, once irradiated onto the workpiece 44, will damage portions of the electronic display above or below the color filters. Laser pulses output by the optical repair system 34 may be Gaussian, or the optical repair system 34 may optionally include beam shaping optics configured to reshape the laser pulses as desired.

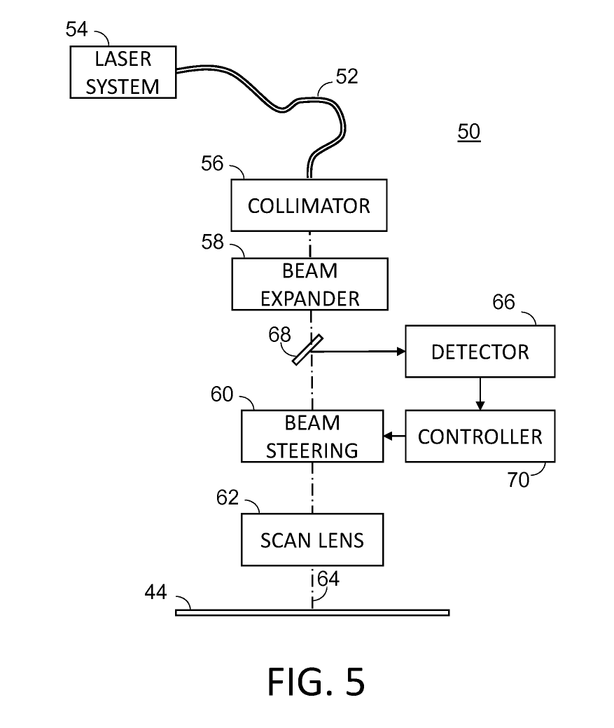

In one embodiment, the optical repair system 34 is implemented as a free-space optical repair system that includes optics (e.g., lenses, mirrors, etc.) for transmitting laser radiation from the laser system to other, optically “down-stream” components (e.g., the beam steering system, the scan lens, etc.). In this implementation, the laser system is typically mounted to the gantry 30. In another embodiment, the optical repair system can be implemented as a fiber-optic beam delivery optical repair system, which includes an optical fiber interposed between two components of the optical repair system. For example, and with reference to FIG. 5, a fiber-optic beam delivery optical repair system, such as optical repair system 50, can include an optical fiber (e.g., indicated at 52) interposed between an optical output of the laser system (e.g., indicated at 54) and an optical input of a component (e.g., a collimator, as indicated at 56) that is optically “downstream” from the laser system. Thus, the optical fiber can optically couple the output of the laser system to the optically downstream components.

Although not shown in FIG. 5, input coupling optics (e.g., one or more beam expanders, focusing lenses, etc.) are provided to couple laser light output from the laser system 54 into the input of the optical fiber 52, output coupling optics (optional) provided to collect and focus light exiting the output of the optical fiber 52, fiber end connections (e.g., mechanically connected to the input and output of the optical fiber to facilitate connection with components of the optical repair system, to facilitate fiber alignment and/or replacement, dissipate reflected laser light, etc.), or the like or any combination thereof.

By interposing an optical fiber of suitable length between components of the optical repair system 50, optical components disposed at the output of the optical fiber 52 (e.g., a collimator 56, beam expander 58, beam steering system 60, scan lens 62, etc.) can be moved relative to optical components disposed at the input of the optical fiber 52 (e.g., the laser system 54). Thus, according to one embodiment, components such as the collimator 56, beam expander 58, beam steering system 60 and scan lens 62 (collectively referred to as “downstream components”) can be mounted to the gantry 30, and the laser system 54 can be mounted to the workpiece support structure 32 (or to some other frame or base, not shown), which can remain at least substantially stationary relative to the gantry 30 (e.g., if the gantry 30 is moved relative to the workpiece support structure 32), relative to one or more of the downstream components (e.g., if one or more of the downstream components are moved relative to the gantry 30), or the like or a combination thereof.

Generally, the optical fiber 52 can be provided as a polarization-maintaining fiber, such as a hollow core photonic crystal fiber. Generally, hollow core photonic crystal fibers have a cross-section (normally uniform along the fiber length) that is microstructured from at least one materials, most commonly arranged periodically over much of the cross-section, and usually as a “cladding” surrounding one or several cores, where light is to be confined. The cores can be filled with air or other gas. Some hollow core photonic crystal fibers exhibit mode field diameter in a range from 20 μm (or thereabout) and 100 μm (or thereabout). Having such a large mode field diameter tend to reduce non-linear effect that can lead to dramatic interface failure and/or pulse width increase due to Self Phase Modulation (SPM). Suitable hollow core photonic crystal fibers will also have a group velocity dispersion of about 3 ps/(nm*km). In the optical repair system 50, the optical fiber 52 has a length in a range from 1 m (or thereabout) to 10 m (or thereabout). Hollow core photonic crystal fibers suitable for use in the optical repair system 50 can be obtained from manufacturers such as PT PHOTONIC TOOLS GmbH and NKT PHOTONICS A/S.

Constructed as exemplarily described above, the optical repair system 50 is configured to generate and output laser light (either as a beam of laser pulses, or as a continuous beam of laser light) at the laser system 54, which is then delivered to the downstream components via the optical fiber 52 to be propagated along a beam path 64 (along which the downstream components are disposed and which, ultimately, intersects the workpiece 44). If a downstream component (such as the collimator 56) is moved relative to the laser system 54 (e.g., by moving the gantry 30 relative to the workpiece support structure 32, by moving the downstream component relative to the gantry 30, etc.), then the optical fiber 52 may flex to permit or otherwise accommodate such relative motion. When the optical fiber 52 flexes, it is possible that one or more characteristics of the beam (e.g., spatial intensity distribution, centroid, etc.) will change as laser light is transmitted from the input of the optical fiber 52 to the output centroid of the optical fiber 52. This phenomenon will hereinafter be referred to as “fiber bending-induced shift.” For example, if the collimator 56 is moved along the X-axis (e.g., to the right along the X-axis, as shown in FIG. 4), then the centroid of the beam at the output of the optical fiber 52 may shift (e.g., to the right, depending upon configuration of the optical fiber 52, the manner in which the optical fiber 52 is packaged within the optical repair system 50, etc.). To counteract or otherwise mitigate the effects of fiber bending-induced shift, the optical repair system 50 may include a shift-correction system.

In the illustrated embodiment, the shift-correction system may include a detector 66 optically coupled to the beam path 64 (e.g., via a beam splitter 68, such as a half-silvered mirror, that is disposed in the beam path 64, via a reflective mirror coupled to an actuator configured to move the minor into and out of the beam path 64, etc.) and a controller 70 communicatively coupled to the beam steering system 60. Generally, the detector 66 includes an optical sensor operative to detect or otherwise sense laser light propagating along the beam path 64 from the beam expander 58 and generate a detector signal corresponding to the detected or sensed laser light. The optical sensor can include a CCD camera, an infrared matrix array, a photodiode or an array thereof, a pyroelectric detector, a thermopile detector, or the like or any combination thereof. Examples of photodiodes that may be used include Si-junction photodiodes, InGaAs-junction photodiodes, InGaAsP-junction photodiodes etc. In one embodiment, the detector 66 is provided as a camera-based beam profiler, a scanning beam profiler (e.g., based on one or more slits, knife edges, apertures, etc.), or the like or any combination thereof.

The detector signal is thereafter transmitted to the controller 70, where it is processed to determine whether one or more characteristics of the beam (e.g., spatial intensity distribution, centroid, etc.) is outside a predetermined threshold amount for each characteristic (e.g., in terms of circularity or ellipticity, in terms of centroid location, etc.). Data relating to the threshold amount for a characteristic can be stored in memory device (not shown) accessible by the controller 70. If a characteristic of the beam is determined to be outside the threshold amount, the controller 70 can generate a correction signal, and output the correction signal to the beam steering system 60. Upon receipt of the correction signal, the beam steering system 60 modifies the beam incident upon it (e.g., by reflecting the beam, diffracting the beam, refracting the beam, or the like or any combination thereof) so that the characteristic of the modified beam (i.e., propagated from the beam steering system 60 to the scan lens 62) is within the threshold amount.

Although not illustrated, a visual inspection system can also be provided to visually inspect the electronic display device to discern the presence of viewing elements exhibiting bright pixel defects or dark pixel defects, to discern the locations of viewing elements exhibiting bright pixel defects or dark pixel defects (e.g., relative to the optical repair system 34 or 50, relative to the electronic display device, or the like or any combination thereof), and to generate one or more appropriate output signals to the relative position system and/or the beam steering system so that laser pulses can be irradiated onto viewing elements exhibiting bright pixel defects. Accordingly, the visual inspection system may include a camera configured to capture imagery of the electronic display device and generate inspection data therefrom, an image processor configured to process the inspection data and generate the aforementioned output signals.

Although not illustrated, the optical repair system 34 or 50 may include a polarization unit for modifying a polarization of the laser light (e.g., a beam of laser pulses, a continuous beam of laser light, etc.) incident upon the workpiece 44. Modifying the polarization of the laser light can be helpful in some repair applications (e.g., when repairing an LCD, etc.) to increase coupling of the incident laser light with the workpiece 44. Exemplary embodiments of a polarization unit that may be incorporated into the optical repair system 34 or 50 (along with related components supporting an operation thereof) are discussed in U.S. Patent App. Pub. No. 2014/0256205, which is incorporated herein by reference in its entirety.

Although not illustrated, it will be appreciated that operations of the optical repair system 34 or 50 (or of any of the components thereof), and gantry 30, may be controlled via one or more controllers communicatively coupled thereto. A controller can be provided as a programmable processor (e.g., including one or more general purpose computer processors, microprocessors, digital signal processors, or the like or any combination thereof) configured to execute instructions. These instructions may be implemented software, firmware, etc., or in any suitable form of circuitry including programmable logic devices (PLDs), field-programmable gate arrays (FPGAs), field-programmable object arrays (FPGAs), application-specific integrated circuits (ASICs)—including digital, analog and mixed analog/digital circuitry—or the like, or any combination thereof. Execution of instructions can be performed on one processor, distributed among processors, made parallel across processors within a device or across a network of devices, or the like or any combination thereof. Software instructions for implementing the detailed functionality can be readily authored by artisans, from the descriptions provided herein, e.g., written in C, C++, Visual Basic, Java, Python, Tel, Perl, Scheme, Ruby, etc. Software instructions are commonly stored as instructions in one or more data structures conveyed by tangible media, such as magnetic or optical discs, memory cards, ROM, etc., which may be accessed locally, remotely (e.g., across a network), or a combination thereof.

Having described and illustrated various embodiments of the present invention, it will be recognized that the technology is not so limited. For example, while the discussion above has focused on so-called “direct blackening” processes to repair bright pixel defects in LCD panels, it will be appreciated that the “direct blackening” processes discussed above can also be applied to darken color emitters in OLED displays. It will further be appreciated that the optical repair systems described herein can be used to repair other defects (e.g., dark pixel defects, etc.) in LCD panels, OLED displays, and other electronic display devices, regardless of whether they are flat, curved, rigid or flexible. Examples of such other repair processes that may be implemented using the optical repair systems described herein include are discussed in U.S. Pat. Nos. 5,832,595, 6,590,335, 6,605,372, 6,714,269, 7,234,984, 7,701,133, 7,839,077, 7,955,151, 8,148,896, each of which is incorporated herein by reference in its entirety. Although the direct blackening process described herein may be applied to repair flat panel displays having a black matrix, it will be appreciated that the black matrix may be omitted from such displays. It will further be appreciated that the optical repair systems described herein can be used to repair defects in photomasks (e.g., to remove opaque mask material such as Cr, Cu, etc., or alloys thereof). Examples of photomask repair processes that may be implemented using the optical repair systems described herein include are discussed in U.S. Pat. Nos. 6,156,461, 6,582,857, each of which is incorporated herein by reference in its entirety. Further, the optical repair systems described herein can be used to repair defective printed circuit boards (PCBs) (e.g., by ablating conductive shorts). Examples of PCB repair processes that may be implemented using the optical repair systems described herein include are discussed in U.S. Pat. No. 6,046,429 and U.S. Patent App. Pub. No. 2011/0278269, each of which is incorporated herein by reference in its entirety. Likewise, although the fiber delivery system has been discussed in the context of the optical repair system 34, it will be appreciated that the fiber delivery system may be incorporated in any laser-based machining system.

The foregoing is illustrative of embodiments of the invention and is not to be construed as limiting thereof. Although a few specific example embodiments have been described, those skilled in the art will readily appreciate that many modifications to the disclosed exemplary embodiments, as well as other embodiments, are possible without materially departing from the novel teachings and advantages of the invention. Accordingly, all such modifications are intended to be included within the scope of the invention as defined in the claims. For example, skilled persons will appreciate that the subject matter of any sentence or paragraph can be combined with subject matter of some or all of the other sentences or paragraphs, except where such combinations are mutually exclusive. It will be obvious to those having skill in the art that many changes may be made to the details of the above-described embodiments without departing from the underlying principles of the invention. The scope of the present invention should, therefore, be determined by the following claims, with equivalents of the claims to be included therein.

What is claimed is:

1. A method, comprising:
providing an electronic display device having a plurality of viewing elements each comprising a color element, wherein at least one viewing element exhibits a bright pixel defect; and
darkening the color element of at least one viewing element exhibiting the bright pixel defect, the darkening comprising:
irradiating the color element with at least one laser pulse having a pulse duration in a range from 1 ps to 40 ps.

2. The method of claim 1, wherein the at least one laser pulse has a pulse duration less than 15 ps.

3. The method of claim 2, wherein the at least one laser pulse has a pulse duration less than 5 ps.

4. The method of claim 1, wherein the at least one laser pulse has a pulse energy greater than 3 nJ.

5. The method of claim 4, wherein the at least one laser pulse has a pulse energy less than 6 nJ.

6. The method of claim 5, wherein the at least one laser pulse has a spot size at the color element of 3 μm or less.

7. The method of claim 1, wherein the at least one laser pulse has at least one wavelength in the IR range of the electromagnetic spectrum.

8. The method of claim 1, wherein the at least one laser pulse has at least one wavelength in the green range of the electromagnetic spectrum.

9. The method of claim 1, wherein the at least one laser pulse has at least one wavelength in the UV range of the electromagnetic spectrum.

10. The method of claim 1, wherein the color element includes a color filter.

11. An apparatus, comprising:
a workpiece support structure configured to support an electronic display device having a plurality of viewing elements each comprising a color element, wherein at least one viewing element exhibits a bright pixel defect;
an optical repair system configured to darken the color element of at least one viewing element exhibiting the bright pixel defect, the optical repair system including a laser system configured to irradiate the color element with at least one laser pulse having a pulse duration in a range from 1 ps to 40 ps; and
a relative position system configured to move at least one of the workpiece support structure and the optical repair system sufficient to arrange the color element of the at least one viewing element within a processing field of the optical repair system.

12. The apparatus of claim 11, further comprising a visual inspection system coupled to at least one of the relative position system and the optical repair system, the visual inspection system configured to visually inspect the electronic display device.
